(19) United States
(12) Patent Application Publication
(10) Pub. No.: US 2008/0184216 A1
(43) Pub. Date: Jul. 31, 2008

(54) Managing application software in mobile communication devices

(76) Inventor: Johan Muedsam, Plano, TX (US)

Correspondence Address: HARNESS, DICKEY & PIERCE, P.L.C., P.O. BOX 8910, RESTON, VA, 20195, US

(21) Appl. No.: 11/657,470

(22) Filed: Jan. 25, 2007

(51) Int. Cl. G06F 9/44

(52) U.S. Cl. 717/168

(57) ABSTRACT

A method is disclosed for managing application software in a mobile communication device including a first operating environment requiring an authorization from a user of the mobile communication device for managing of application software on top of the first operating environment, and a second operating environment installed on top of the first operating environment, the second operating environment requiring an authorization from the second operating environment only for managing of application software on top of the second operating environment. In at least one embodiment, the method includes receiving an authorization from the second operating environment to manage application software on top of the second operating environment; and managing the application software on top of the second operating environment.

### FIELD OF THE INVENTION

The invention relates mobile communication systems, and in particular to managing application software in mobile communication devices.

### BACKGROUND OF THE INVENTION

Many prior art mobile communication devices have been provided with an operating environment enabling installation of application software which then may be run on the mobile communication device. For example, the mobile communication devices may have a Java virtual machine installed on them. A user may then install a Java application software and run the application software over the Java virtual machine.

One property of the operating environment of prior art mobile communication devices, is that they require user intervention for managing of application software, such as installation, adaptation and updating of the same. The need for user intervention will in turn require skills and effort from the user in terms of managing of application software.

Also the application software to be installed in mobile communication devices in prior art is generally for local use and any managing of the application software or the functions of the application software is generally based on the intention of the user.

### SUMMARY OF THE INVENTION

The invention makes use of the understanding that the above properties of prior art operating environments will pose problems when the same application software is installed on several mobile devices and there is a desire to manage the application software on the mobile communication devices from a remote site.

A method is provided for managing application software in a mobile communication device. The mobile communication device comprises a first operating environment requiring an authorization from a user of the mobile communication device for managing of application software installed on top of the first operating environment. The mobile communication device also comprises a second operating environment on top of the first operating environment, where the second operating environment requiring an authorization from the second operating environment only for managing of application software on top of the second operating environment. In the method an authorization is received from the second operating environment to manage application software on top of the second operating environment, and the application software on top of the second operating environment is managed.

Furthermore, a mobile communication device is provided comprising a first operating environment. The first operating environment requires an authorization from a user of the mobile device for managing of application software on top of the first operating environment. The mobile communication device also comprises a second operating environment on top of the first operating environment. The first application software comprises a second operating environment requiring an authorization from the second operating environment only for managing of a second application software on top of the second operating environment.

Further, a system is provided for managing application software. The system comprises a mobile communication device and a remote server. The mobile communication device comprises a first operating environment requiring an authorization from a user of the mobile communication device for managing of application software on top of the first operating environment. The mobile communication device further comprises a first application software installed on top of the first operating environment. The first application software comprises a second operating environment requiring an authorization from the second operating environment only for managing of a second application software on top of the second operating environment. The remote server comprises a control means adapted for communicating requests for management of application software to the second operating environment of the mobile communication device.

Also, a method for installing application software is provided in a mobile communication device comprising a first operating environment. The first operating environment requires authorization from a user of the mobile communication device to install application software on top of the first operating environment. An authorization is received from the user of the mobile communication device to install a second operating environment. The second operating environment is installed on top of the first operating environment. The second operating environment requires authorization from the second operating environment only, for installing of application software on top of the second operating environment. An authorization is received from the second operating environment to install a second application software on top of the second operating environment and the second application software is installed on top of the second operating environment.

Finally, a computer software adapted for installation in a mobile communication device on top of a first operating environment in the mobile communication device is provided. The first operating environment requires an authorization from a user of the mobile device for managing of application software on top of the first operating environment. The computer software comprises a second operating environment requiring an authorization from the second operating environment only, for managing of a second application software on top of the second operating environment.

By installing the second operating environment on top of the first operating environment, the managing of the second operating environment is governed by the rules of managing of application software in the first operating environment. In particular, the first operating environment requires an authorization from a user of the mobile communication device for managing of the second operating environment. Hence, once installed, the second operating environment may not be managed, such as updated and adapted, without authorization from the user of the mobile communication device.

However, by having the second operating environment requiring an authorization from the second operating environment only, for managing of application software on top of the second operating environment, application software on top of the second operating environment may be managed without the need for user intervention.

In particular, the requiring of an authorization from the second operating environment only, i.e. without the need for authorization from the user of the mobile communication device or the first operating environment, enables control from a remote server of the managing of application software on top of the second operating environment in the mobile communication terminal.

Preferably, the second operating environment will be arranged to authenticate either the remote server or from requests from the remote server for managing of application software on top of the second operating environment. Hence, managing from a remote site is enabled, but such management may not be made from an unauthorized remote server or by means of unauthorized requests depending on the selected embodiment. Together with the need for user authorization for management of the second operating environment, the risk for unauthorized managing of the application software on top of the second operating environment is considerably reduced.

### BRIEF DESCRIPTION OF THE DRAWINGS

In the following, embodiments of the invention will be described in relation to the environment and systems in which they may be advantageously employed, and with reference to the enclosed drawings on which:

FIG. 1 shows a flow chart of a general method of installing computer software in a mobile communication device in accordance with the teachings of the invention, FIG. 2 shows a flow chart of a general method of managing computer software in a mobile communication device in accordance with the teachings of the invention,

FIG. 3 shows a block diagram of a system in which embodiments of the invention may be advantageously employed,

FIG. 4a and 4b shows display images used for data input in application software used in the system of FIG. 3, and

FIG. 5 shows a flow chart of a method of an embodiment of the invention as implemented in the system of FIG. 3.

### DETAILED DESCRIPTION OF EMBODIMENTS

Embodiments of the invention are advantageously used in systems where application software is to be used in a mobile communication device and there is a desire to manage the application software from a remote server.

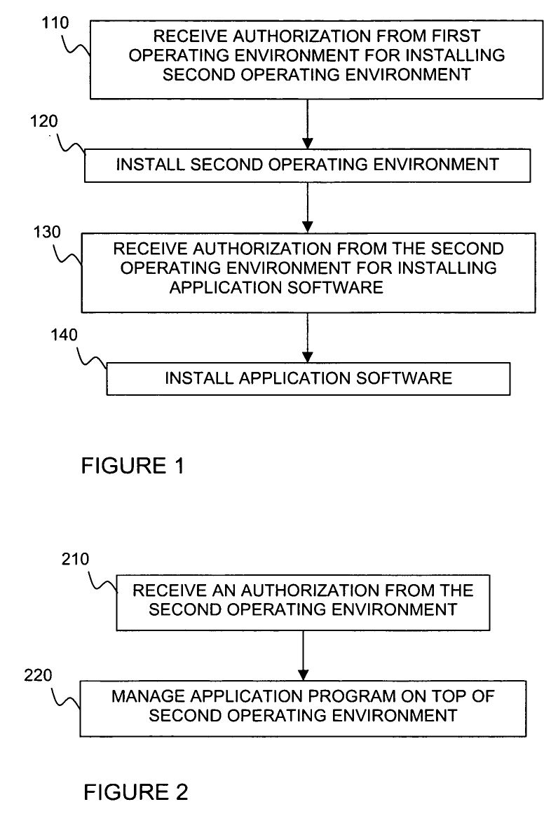

A general embodiment of a method for installing application software in a mobile communication device is illustrated in FIG. 1. The mobile communication device comprises a first operating environment. The first operating environment requires authorization from a user of the mobile communication device to install application software on top of the first operating environment. An authorization is received 110 from the user of the mobile communication device to install a second operating environment on top of the first operating environment. The second operating environment requires authorization from the second operating environment only, for installing of application software on top of the second operating environment. Then the second operating environment is installed 120 on top of the first operating environment. An authorization is received 130 from the second operating environment to install application software on top of the second operating environment and the application software is installed 140 on top of the second operating environment.

The application software may either be pushed from a remote server or the second operating environment may request the application software from the remote server for installing on top of the second operating environment. Preferably, the first operating environment authenticates the second operating environment for installing on top of the first operating environment, and the second operating environment authenticates the application software for installing on top of the second operating environment.

The authentication of the application software for installing on top of the second operating environment may be done directly or indirectly by authentication of the remote server from which the application software is requested.

In alternative to the embodiment of FIG. 1, the second operating environment may be installed on top of the first operating environment by authorization from an mobile communication device vendor or mobile communication operator. Such an alternative would remove also the need for user intervention for installation of the second operating environment.

Also the user of the mobile communication device at the time of installation of the second operating environment may not be the owner or normal user of the mobile communication device, but may be a person representing the producer of the second operating environment or some other service person representing some other entity.

A general embodiment of a method for managing application software in a mobile communication device is illustrated in FIG. 2. The mobile communication device comprises a first operating environment which requires an authorization from a user of the mobile communication device for managing of application software installed on top of the first operating environment. The mobile communication device also comprises a second operating environment on top of the first operating environment, where the second operating environment requires an authorization from the second operating environment only, for managing of application software on top of the second operating environment. In the method an authorization is received 210 from the second operating environment to manage application software on top of the second operating environment, and the application software on top of the second operating environment is managed 220.

Preferably the managing of the application software on top of the second operating environment is controlled by a remote server. The second operating environment will typically ensure that the managing of the application software on top of the second operating environment is secure. This may e.g. be done by authentication of the source itself, i.e. the remote server, or by authentication of requests for managing sent from the remote server. Suitable means for such authentication are well know to a skilled person within the art.

In a particular implementation in line with the teachings of the invention, the first operating environment used is J2ME. The second operating environment is a Virtual Machine in the form of a Scheme interpreter implemented on top of J2ME.

The Virtual Machine used is an implementation of Scheme. The Virtual Machine is written in Java and is implemented on top of J2ME. A compiler takes Scheme code and creates executable code that can be run in the Virtual Machine. Any application software to be run in the Virtual Machine is written in Scheme and is compiled and then compressed using gzip before being distributed from the remote server to the mobile communication devices.

For further information regarding scheme, J2ME and gzip turn to:
http://www.swiss.ai.mit.edu/projects/scheme/index.html
http://java.sun.com/javame/index.jsp
http://www.gzip.org/algorithm.txt.

For the first installation of the Virtual Machine on the mobile communication device, a version of the application software code may be distributed together with the Virtual Machine to the mobile communication device.

In the case where no application software is present the first time the Virtual Machine is started in the mobile communication terminal, an application software update is requested from the remote server.

The first time the Virtual Machine is started it stores the application software in a database on the mobile device. The Virtual Machine will run the application software present in the mobile device database.

For all updates to the application software after the first installation, the mobile communication device retrieves the application software from the remote (update) server. The version of the application software that is to be installed on a specific mobile communication device is controlled centrally by the remote server. The server can notify the mobile communication device that it needs to update the application software or the mobile communication device can ask the remote server if it needs to update the application software.

As the Virtual Machine implemented on top of J2ME may authorize management of application software run on top of the Virtual Machine, the mobile communication devices can pull application software updates from the remote server and install them on top of the Virtual Machine without user intervention. The updated application software is then stored in the database on the mobile device.

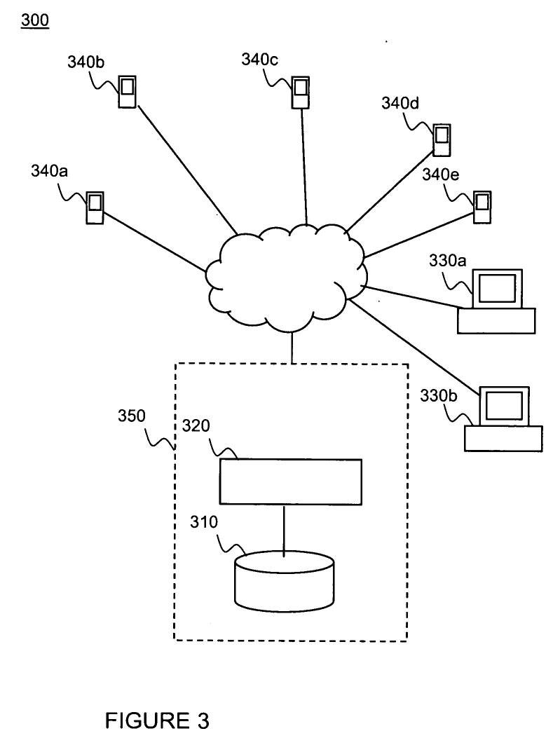

FIG. 3 shows a block diagram of a system 300 in which embodiments of the invention may be advantageously employed. The system 300 is an interactive system for continuous follow up of the health-situation of patients, e.g. in order to monitor the effect of one or more types of medications which the patients are taking. However, the teachings of the invention is of course applicable to other system where application software run in a mobile communication device, such a mobile phone, is to be managed from a remote server.

The system 300 may be used to identify an individual medication scheme for one or more patients. In such a case, the system uses continuous registrations of data made by the patients regarding their health-situation. The scheme for registration is normally based on their particular diagnosis and choices made by a physician. The patients use mobile communication devices, e.g. in the form of mobile phones, for registration, and the physician and/or nurse use PC:s and Internet to view and evaluate the patients' health-status development.

The system 300 may also be used to perform medical studies on a set of subjects taking a medication. In such a case the system uses continuous registrations of data made by the patients regarding their health-situation and taking of medication.

The system may also be used in several other applications for monitoring the health-situation of a person over time, such as monitoring a person's weight reduction e.g. in view of prescribed physical activity and/or diet.

Schematically, the system 300 in FIG. 3 consists of three parts: * a database 310 in combination with a server 320 where all information and patient registrations are stored and which control management of application software in the mobile devices,

an Internet application with which the physicians and nurses (and patients if they are allowed to) are communicating, using Internet Explorer or a similar tool on their PC 330a-b, and

application software (mobile application) installed on a patient's mobile communication device 340a-e and used by the patient to make registrations, and communicating with the Internet application.

The database 310, server and Internet application are located in a unit 350 remote from the mobile communication devices. The unit 350 is collects data from all of the mobile communication devices 340a-e, whereas the mobile communication devices 340a-e, with respect to this application, generally only communicates with the unit 350. The unit 350 in itself may be located in one physical unit but may just as well be distributed in separate physical units. An instance of the application software is located in each mobile communication device 340a-e.

The communication between the application software, installed on the patient's mobile communication device 340a-e, and the Internet application, may be completely automatic and accomplished using a mobile communication system for transportation of data.

The unit 350 can be put together in several different ways but a typical way is to have a web server that fronts the database. The web server accepts remote calls over https or http (depending on security preferences) at a specific path.

The mobile communication device is preferably a unit that can communicate over https or http, e.g. a mobile phone.

In the case of a mobile phone, the phone can transfer the data in several different ways. Either the mobile phone transfers the data formatted in a specific XML-format over https or http via the cellular network (GPRS or WCDMA), or the communication is based on SMS. Another example could be a WAP-interface.

Data are collected with respect to a number of health related variables. The term “health related variable” refers to a factor which is relevant to a person's health and which may vary over time. Such health related variables are of interest e.g. when monitoring the effect of a medication, or other prescriptions such as physical activity or diet, on a patient (or subject). A health related variable can e.g. be a patient experienced/subjective condition or a measurable/objective condition or an activity. Examples of patient experienced conditions are pain, fatigue, mood, etc. Examples of measurable conditions are blood pressure, blood sugar level, ECG, EEG, weight etc. Examples of activities are diet, sleep, physical strain, taking of medication etc.

Depending on the health related variable, the data input may be of different formats. For example, for a patient experienced condition, such as pain, the input may be a subjectively relative value, such as a scale from no pain to unbearable pain. For a condition which can be measured, such as blood pressure, the input may be a numerical value.

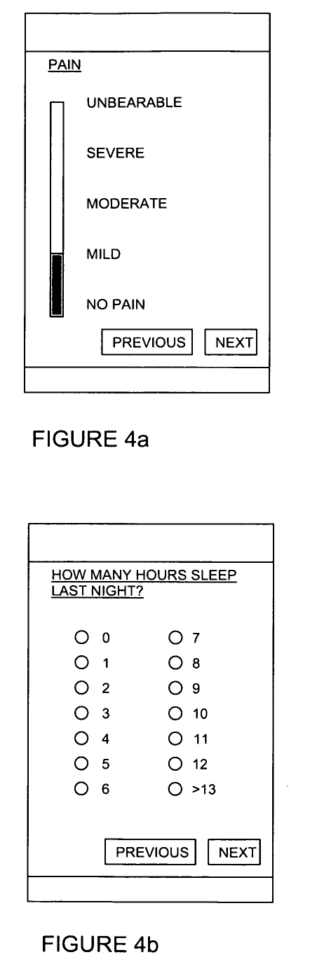

Data for a specific health related variable is normally collected by stating the health related variable or by stating a question with respect to the health related variable. The patient then provides data with respect to the health related variable, e.g. by selecting one of a number of options given, or by providing a numerical or textual input. For example, as shown in FIG. 4a, the health related variable “Pain” is shown on the display of the mobile phone of the patient together with a scale indicating “unbearable”, “severe”, “moderate”, “mild” and “no pain”. In this case the patient would respond by indicating the pain on that scale. In another example shown in FIG. 4b, the question “How many hours did you sleep last night?” referring to the health related variable ‘sleep’ is being shown on the display. In this case the patient would respond by input of a numeric value, e.g. by using the key pad of the mobile phone or by selecting one of a number of given alternatives given on the display.

In the case where system 300 of FIG. 3 is used for designing an individualized medication scheme, the set of health related variables is normally selected by a physician based on the diagnosis of the patient, general rules and first observations of the patient. The set of health related variables may then be updated regularly, e.g. in view of the result of the patients data registration for the health related parameters.

In the case where the system 300 of FIG. 3 is used in a study of a medication and its effects, the set of health related variables is normally selected by the person or organization performing the study and includes health related variables of interest in the study. The same persons may participate in different studies for the same or different medications. The set of health related parameters will need to be updated between studies.

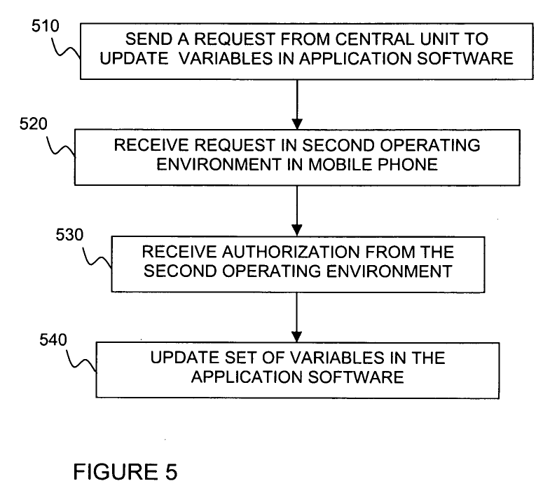

The teachings of the invention with respect to managing of application software in mobile communication terminals may be applied in the system of FIG. 3. In particular, and with reference to FIG. 5, a set of health related variables defined in application software in a mobile phone of a patient may be managed. The application software is installed on top of a second operating environment which in turn is installed on top of a first operating environment. A request to manage the application software on top of the second operating environment in the mobile device of the patient is sent 510 from a server to the second operating environment. The managing in this case may e.g. consists of updating the set of health related variables to an updated set of health related variables.

The second operating environment receives 520 the request and optionally authenticates the request or the server from which it is received. The second operating environment then authorizes 530 updating the set of health related parameters in the application software and the set health related parameters are updated 540 to an updated set of health related parameters.

In a similar way as described with reference to FIG. 5, the application software may be managed from remote in any desired way, e.g. in order to alter the data requested from the user, altering the user interface, installing an updated version of the application software, etc.

It is to be noted that even if embodiments have been described where the first operating environment is J2ME, the invention is also applicable to other operating environments for mobile communication devices, such as Symbian, BREW and Microsoft Mobile, etc.

1. A method for managing application software in a mobile communication device comprising a first operating environment requiring an authorization from a user of the mobile communication device for managing of application software on top of the first operating environment, and a second operating environment installed on top of the first operating environment, the second operating environment requiring an authorization from the second operating environment only for managing of application software on top of the second operating environment;
receiving an authorization from the second operating environment to manage application software on top of the second operating environment; and
managing the application software on top of the second operating environment.

2. The method of claim 1, further comprising:
receiving, from a remote server, a request for managing of the application software on top of the second operating environment.

3. The method of claim 2, further comprising:
the second operating environment authenticating the remote server.

4. The method of claim 2, further comprising:
the second operating environment authenticating the request for managing of the application software on top of the second operating environment.

5. The method of claim 1, wherein the second operating environment is a virtual machine.

6. The method of claim 1, wherein managing of the application software on top of the second operating environment includes at least one of installing the application software, updating the installed application software, and adapting the application software on top of the second operating environment.

7. A mobile communication device comprising:
a first operating environment requiring an authorization from a user of the mobile device for managing of application software on top of the first operating environment; and
a second operating environment on top of the first operating environment, the second operating environment requiring an authorization from the second operating environment only for managing of application software on top of the second operating environment.

8. The mobile communication device of claim 7, further comprising:
a receiving means for receiving, from a remote server, a request for managing the application software on top of the second operating environment.

9. The mobile communication device of claim 7, wherein managing of the application software on top of the second operating environment includes at least one of installing the application software, updating the installed application software, and adapting the application software on top of the second operating environment.

10. The mobile communication device of claim 8, wherein the second operating environment is adapted for authenticating the request for managing the application software on top of the second operating environment.

11. The mobile communication device of claim 8, wherein the second operating environment is arranged for authenticating the remote server.

12. The mobile communication device of claim 7, wherein the first operating environment is adapted for authenticating the first application software.

13. The mobile communication device of claim 7, wherein the second operating environment is a virtual machine.

14. A system for managing application software, comprising:
a mobile communication device comprising:
a first operating environment requiring an authorization from a user of the mobile communication device for managing of application software on top of the first operating environment;
a second operating environment on top of the first operating environment, the second operating environment requiring an authorization from the second operating environment only for managing of application software on top of the second operating environment, and
a remote server comprising:
a control means adapted for communicating requests for managing of application software on top of the second operating environment to the second operating environment of the mobile communication device.

15. The system of claim 14, wherein said mobile communication device further comprises:
a receiving means for receiving, from the remote server, a request for managing the application software on top of the second operating environment.

16. The system of claim 14, wherein managing of the application software on top of the second operating environment includes at least one of installing the application software, updating the installed application software, and adapting the application software on top of the second operating environment.

17. The system of claim 15, wherein the second operating environment is adapted for authenticating the request for managing the application software on top of the second operating environment.

18. The system of claim 15, wherein the second operating environment is arranged for authenticating the remote server.

19. The system of claim 14, wherein the first operating environment is adapted for authenticating the first application software.

20. The system of claim 14, wherein the second operating environment is a virtual machine.

21. A method for installing application software on a mobile communication device comprising a first operating environment requiring an authorization from a user of the mobile communication device for installing of application software on top of the first operating environment, comprising:
receiving an authorization from the user of the mobile communication device to install a second operating environment on top of the first operating environment;
installing the second operating environment on top of the first operating environment, the second operating environment requiring an authorization from the second operating environment only, for installing of application software on top of the second operating environment;
receiving an authorization from the second operating environment to install application software on top of the second operating environment; and
installing the application software on top of the second operating environment.

22. The method of claim 21, further comprising:
receiving the application software from a remote server for installing on top of the second operating environment.

23. The method of claim 22, further comprising:
requesting the application software from the remote server for installing on top of the second operating environment.

24. The method of claim 21, further comprising:
the first operating environment authenticating the second operating environment for installing on top of the first operating environment.

25. The method of claim 21, further comprising:
the second operating environment authenticating the application software for installing on top of the second operating environment.

26. The method of claim 22, further comprising:
the second operating environment authenticating the remote server.

27. Computer software adapted for installation in a mobile communication device on top of a first operating environment in the mobile communication device, the first operating environment requiring an authorization from a user of the mobile device for managing of application software on top of the first operating environment, the computer software comprising a second operating environment requiring an authorization from the second operating environment only, for managing of application software on top of the second operating environment.
